(19) United States
(12) Patent Application Publication
(10) Pub. No.: US 2015/0252137 A1
(43) Pub. Date: Sep. 10, 2015

(54) Melamine Container

(71) Applicant: Hsing-Yi Chen, Tainan City (TW)

(72) Inventor: Hsing-Yi Chen, Tainan City (TW)

(21) Appl. No.: 14/195,918

(22) Filed: Mar. 4, 2014

(51) Int. Cl. C08G 12/32

(52) U.S. Cl. CPC C08G 12/32

(57) ABSTRACT

A melamine container is hot pressed and contains: melamine powder material, melamine-granule basic material, bakelite powders/granules and urea powders/granules. The melamine-granule basic material is condensed from the melamine powder material so as to form granules, and the melamine-granule basic material and the melamine powder material are mixed and hot pressed together so as to produce the melamine container. Furthermore, a melamine container is hot pressed and contains at least two melamine-granule basic materials, bakelite powders/granules and urea powders/granules; wherein the at least two melamine-granule basic materials are condensed from melamine powder material so as to form granules of at least two colors, and the at least two melamine-granule basic materials are mixed and hot pressed so as to produce a melamine container.

### FIELD OF THE INVENTION

The present invention relates to a melamine container which is made of melamine powder material and melamine-granule basic material so as to obtain various appearances.

### BACKGROUND OF THE INVENTION

A conventional melamine container includes melamine basic material, melamine resin material, and a plurality of xylems, wherein the melamine basic material is hot pressed from melamine powders/granules, melted with the melamine resin material, and is adhered with and covered by the plurality of xylems. The melamine basic material, the melamine resin material, and the plurality of xylems are hot pressed respectively and then are mixed and hot pressed together, thereby producing the conventional melamine container troublesomely at high cost.

Another conventional melamine container includes melamine powders/granules, melamine basic material which is hot pressed, and then the melamine basic material and melamine-granule secondary material which has been hot pressed are mixed and hot pressed together, hence the melamine-granule secondary material is not melted to avoid damage. Nevertheless, such a manufacturing process is complicated and causes high production cost.

The present invention has arisen to mitigate and/or obviate the afore-described disadvantages.

### SUMMARY OF THE INVENTION

The primary objective of the present invention is to provide a melamine container in which melamine-granule basic material is condensed from melamine powder material so as to form granules of various sizes and to eliminate hot pressing process, thus reducing manufacture cost.

Further objective of the present invention is to provide a melamine container in which the melamine-granule basic material and the melamine powder material are hot pressed to cause deformation, thereby preventing damage and presenting various colors and appearances.

Another objective of the present invention is to provide a melamine container which has various colors so as to comply with using requirement.

### BRIEF DESCRIPTION OF THE DRAWINGS

FIG. 1 is a perspective view showing the assembly of a melamine container according to a preferred embodiment of the present invention.

### DETAILED DESCRIPTION OF THE PREFERRED EMBODIMENTS

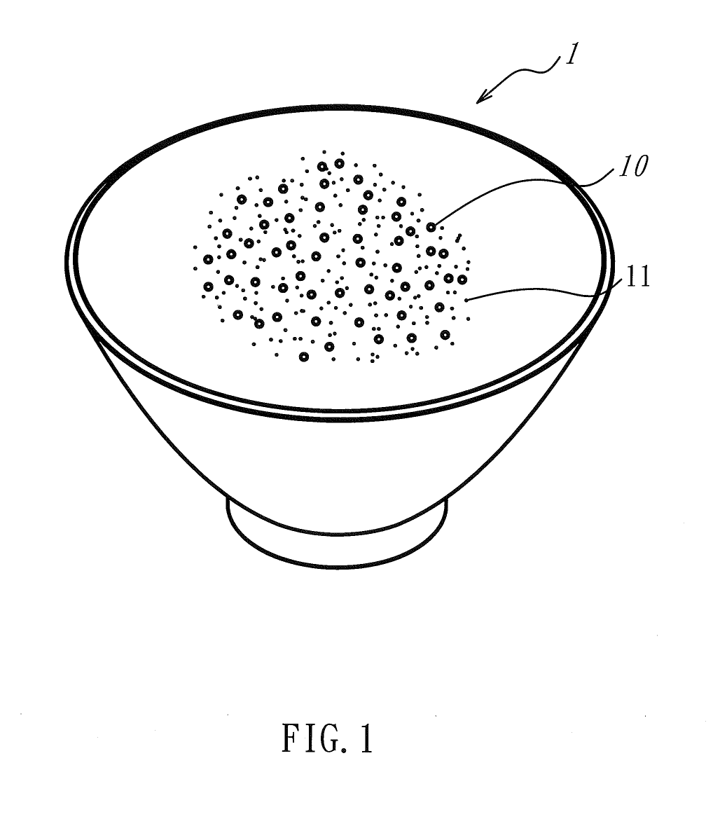

With reference to FIG. 1, a melamine container according to a preferred embodiment of the present invention comprises: a body 1 of various shapes, wherein melamine powder material 10 and one or at least two melamine-granule basic materials 11 are mixed and hot pressed together so as to form the body 1, and the melamine powder material 10 has a single color; one or the at least two melamine-granule basic materials 11 are condensed from the melamine powder material 10 so as to form granules of various colors and sizes.

When the melamine powder material 10 and one or the at least two melamine-granule basic materials 11 of a single color and a single size are mixed and hot pressed together, such that they will not be broken and will deform and present at least one color on an outer surface of the body 1, thus obtaining various appearances.

Before a hot pressing process, a color of the melamine powder material 10 is selected, and a ratio of each of a granule combination and a color mixing is adjusted, thereafter the melamine powder material 10 and one or the at least two melamine-granule basic materials 11 are hot pressed so as to comply with using requirement.

Thereby, one or the at least two melamine-granule basic materials 11 and the melamine powder material 10 are mixed and hot pressed together so as to form the body 1, wherein one or the at least two melamine-granule basic materials 11 include the granules of at least one color and at least one size, and the melamine powder material 10 has the single color.

Preferably, the at least two melamine-granule basic materials 11 include the granules of at least two colors and one size.

Each of the at least two melamine-granule basic materials 11 is replaced by bakelite powders/granules or urea powders/granules, such that the bakelite powders/granules or the urea powders/granules and the melamine powder material 10 are mixed and hot pressed together so as to produce the body 1.

The melamine powder material 10 is replaced by bakelite powders/granules or urea powders/granules, such that the bakelite powders/granules or the urea powders/granules and one or the at least two melamine-granule basic materials 11 are mixed and hot pressed together so as to produce the body 1, wherein each melamine-granule basic material 11 is non-toxic.

The bakelite powders/granules or the urea powder/granules, the melamine powder material 10, and each melamine-granule basic material 11 are mixed and hot pressed together so as to produce the body 1, wherein the melamine powder material 10 and each melamine-granule basic material 11 are non-toxic.

While we have shown and described various embodiments in accordance with the present invention, it is clear to those skilled in the art that further embodiments may be made without departing from the scope of the present invention.

What is claimed is:

1. A melamine container being hot pressed and comprising: melamine powder material, a melamine-granule basic material, bakelite powders/granules and urea powders/granules;
wherein the melamine-granule basic materials is condensed from the melamine powder material so as to form granules, and the melamine-granule basic material and the melamine powder material are mixed and hot pressed together so as to produce a melamine container.

2. The melamine container as claimed in claim 1, wherein the melamine powder material has a single color, and the melamine-granule basic material includes the granules of one or at least two colors and one or at least two sizes.

3. The melamine container as claimed in claim 1, wherein the melamine-granule basic material is replaced by bakelite powders/granules or urea powders/granules.

4. The melamine container as claimed in claim 1, wherein the melamine powder material is replaced by bakelite powders/granules or urea powders/granules.

5. The melamine container as claimed in claim 1, wherein the bakelite powders/granules or the urea powders/granules, the melamine powder material, and the melamine-granule basic material are mixed and hot pressed together to produce the melamine container.

6. A melamine container being hot pressed and comprising: at least two melamine-granule basic materials, bakelite powders/granules and urea powders/granules;
wherein the at least two melamine-granule basic materials are condensed from melamine powder material so as to form granules of at least two colors, and the at least two melamine-granule basic materials are mixed and hot pressed so as to produce a melamine container.

7. The melamine container as claimed in claim 6, wherein the at least two melamine-granule basic materials include the granules of one size or at least two sizes.

8. The melamine container as claimed in claim 6, wherein each of a part of the at least two melamine-granule basic materials is replaced by bakelite powders/granules or urea powders/granules.
